(19) United States
(12) Patent Application Publication
(10) Pub. No.: US 2026/0022987 A1
(43) Pub. Date: Jan. 22, 2026

(54) INFORMATION PROCESSING APPARATUS, INFORMATION PROCESSING METHOD, AND NON-TRANSITORY COMPUTER READABLE MEDIA

(71) Applicant: NEC Corporation, Tokyo (JP)

(72) Inventor: Yuki YAMAGUCHI, Tokyo (JP)

(73) Assignee: NEC Corporation, Tokyo (JP)

(21) Appl. No.: 19/269,197

(22) Filed: Jul. 15, 2025

(30) Foreign Application Priority Data
Jul. 22, 2024 (JP) 2024-116757

(51) Int. Cl. G01M 5/00

(52) U.S. Cl. CPC G01M 5/0041; G01M 5/0008

(57) ABSTRACT

An information processing apparatus segments a plurality of measurement points for each segment of a construction in a two-dimensional image based on three-dimensional position information of the plurality of measurement points included in the construction. The apparatus selects a plurality of pieces of displacement information including displacement amounts of the plurality of measurement points included in a preset period and a set range for the construction. The apparatus calculates a correlation index value representing a correlation for at least one of the segments included in the set range based on the selected displacement information and environment information indicating a state of an environment around the set range. The apparatus generates a determination condition for evaluating soundness of the construction for the at least one segment based on the correlation index value of the at least one segment.

This application is based upon and claims the benefit of priority from Japanese patent application No. 2024-116757, filed on Jul. 22, 2024, the disclosure of which is incorporated herein in its entirety by reference.

### TECHNICAL FIELD

The present invention relates to an information processing apparatus, an information processing method, and a non-transitory computer readable media.

### BACKGROUND ART

For example, WO 2023/135714 A1 discloses a soundness evaluation apparatus that diagnoses soundness of a construction. The soundness evaluation apparatus disclosed in WO 2023/135714 A1 includes a selection unit, a calculation unit, and a generation unit. The selection unit disclosed in WO 2023/135714 A1 selects displacement information of a range from displacement information representing displacement amounts of a plurality of measurement points included in a region including a construction based on a period set in advance and a set range for the construction. The calculation unit disclosed in WO 2023/135714 A1 calculates an index representing a correlation based on displacement information of a range in a period and environment information representing a state of an environment surrounding the range. The generation unit disclosed in WO 2023/135714 A1 generates a determination condition to be used for evaluating the soundness of the construction based on the plurality of calculated indexes.

### SUMMARY

In general, a construction may include a plurality of segments having different characteristics of displacement in accordance with the state of the surrounding environment. For example, in the case of a bridge through which a vehicle passes, there is a bridge configured with a road portion including a road surface through which the vehicle passes, an upper construction portion configuring an upper portion of the road portion, and a lower construction portion configuring a lower portion of the road portion. In the segments such as the road portion, the upper construction portion, and the lower construction portion, characteristics of displacement in accordance with the state of the environment such as the surrounding temperature may be different.

In the soundness evaluation apparatus disclosed in WO 2023/135714 A1, the set range may include measurement points belonging to different segments. In such a case, the accuracy of the value of the index representing the calculated correlation is deteriorated, and thus if the soundness of the construction is evaluated using the determination condition generated based on the value of such an index, the accuracy of the evaluation may be deteriorated.

One of the problems in the present disclosure is to generate a determination condition capable of accurately evaluating soundness of a construction.

An information processing apparatus of the preset disclosure includes
segmentation means for segmenting a plurality of measurement points for each segment of a construction in a two-dimensional image based on three-dimensional position information of the plurality of measurement points included in the construction,
selection means for selecting a plurality of pieces of displacement information including displacement amounts of the plurality of measurement points included in a preset period and a set range for the construction,
calculation means for calculating a correlation index value representing a correlation for at least one of the segments included in the set range based on the selected displacement information and environment information indicating a state of an environment around the set range, and
generation means for generating a determination condition for evaluating soundness of the construction for the at least one segment based on the correlation index value of the at least one segment.

An information processing method
performed by one or more computer according to the present disclosure includes
segmenting a plurality of measurement points for each segment of a construction in a two-dimensional image based on three-dimensional position information of the plurality of measurement points included in the construction,
selecting a plurality of pieces of displacement information including displacement amounts of the plurality of measurement points included in a preset period and a set range for the construction,
calculating a correlation index value representing a correlation for at least one of the segments included in the set range based on the selected displacement information and environment information indicating a state of an environment around the set range, and
generating a determination condition for evaluating soundness of the construction for the at least one segment based on the correlation index value of the at least one segment.

A program according to the present disclosure
causes one or more computer to perform:
segmenting a plurality of measurement points for each segment of a construction in a two-dimensional image based on three-dimensional position information of the plurality of measurement points included in the construction,
selecting a plurality of pieces of displacement information including displacement amounts of the plurality of measurement points included in a preset period and a set range for the construction,
calculating a correlation index value representing a correlation for at least one of the segments included in the set range based on the selected displacement information and environment information indicating a state of an environment around the set range, and
generating a determination condition for evaluating soundness of the construction for the at least one segment based on the correlation index value of the at least one segment.

An example advantage according to the present disclosure, it is possible to generate a determination condition capable of accurately evaluating soundness of a construction.

### BRIEF DESCRIPTION OF THE DRAWINGS

FIG. 1 is a block diagram illustrating an outline of a configuration of a first information processing apparatus according to the present disclosure;

FIG. 2 is a flowchart illustrating an outline of a processing operation of the first information processing apparatus according to the present disclosure;

FIG. 3 is a diagram of a bridge that is an example of a construction to be evaluated according to the present disclosure viewed from above;

FIG. 4 is a diagram of a bridge that is an example of the construction to be evaluated according to the present disclosure viewed from a side;

FIG. 5 is a block diagram illustrating a detailed example of a configuration of the first information processing apparatus according to the present disclosure;

FIG. 6 is a diagram illustrating an example in which measurement points included in a bridge that is an example of a construction to be evaluated according to the present disclosure are segmented into segments;

FIG. 7 is a diagram illustrating a configuration example of a screen for a user to designate a period and a range in the present disclosure;

FIG. 8 is a block diagram illustrating a configuration example of a first selection unit according to the present disclosure;

FIG. 9 is a block diagram illustrating a configuration example of a first calculation unit according to the present disclosure;

FIG. 10 is a diagram illustrating an example of a box-and-whisker diagram illustrating a correlation between a displacement amount and an environment state value according to the present disclosure;

FIG. 11 is a flowchart illustrating a detailed example of a processing operation of the first information processing apparatus according to the present disclosure;

FIG. 12 is a diagram illustrating a physical configuration example of the first information processing apparatus according to the present disclosure;

FIG. 13 is a block diagram illustrating a configuration example of a second information processing apparatus according to the present disclosure;

FIG. 14 is a block diagram illustrating a configuration example of a second calculation unit according to the present disclosure;

FIG. 15 is a flowchart illustrating a processing operation example of the second information processing apparatus according to the present disclosure;

FIG. 16 is a block diagram illustrating a configuration example of a third information processing apparatus according to the present disclosure; and

FIG. 17 is a flowchart illustrating a processing operation example of the third information processing apparatus according to the present disclosure.

### EXAMPLE EMBODIMENT

Hereinafter, in the present disclosure, the drawings are associated with one or more example embodiments. In all the drawings, the same components are denoted by the same reference numerals, and the description thereof is omitted as appropriate.

### First Example Embodiment

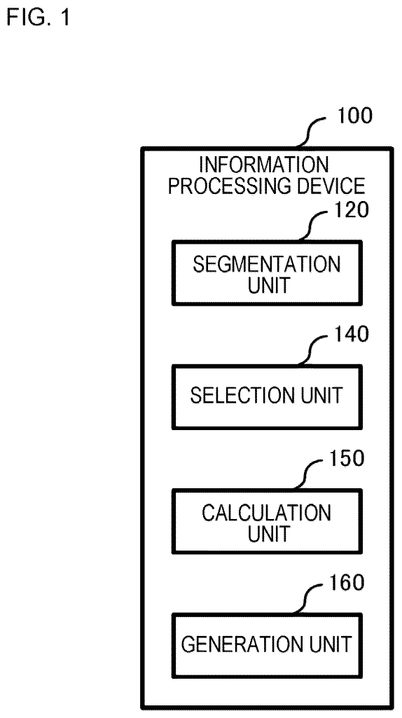

As illustrated in FIG. 1, an information processing apparatus 100 according to the present disclosure includes a segmentation unit 120, a selection unit 140, a calculation unit 150, and a generation unit 160.

The segmentation unit 120 segments a plurality of measurement points for each segment of a construction in a two-dimensional image based on three-dimensional position information of the plurality of measurement points included in the construction. The selection unit 140 selects a plurality of pieces of displacement information including displacement amounts of the plurality of measurement points included in a preset period and a set range for the construction. The calculation unit 150 calculates a correlation index value representing a correlation for at least one of the segments included in the set range based on the selected displacement information and environment information indicating a state of an environment around the set range. The generation unit 160 generates a determination condition for evaluating soundness of the construction for the at least one segment based on the index value of the at least one segment.

According to the information processing apparatus 100, a plurality of measurement points can be segmented for each segment of a construction, and a determination condition for the segment can be generated. It is possible to generate a determination condition capable of accurately evaluating soundness of a construction.

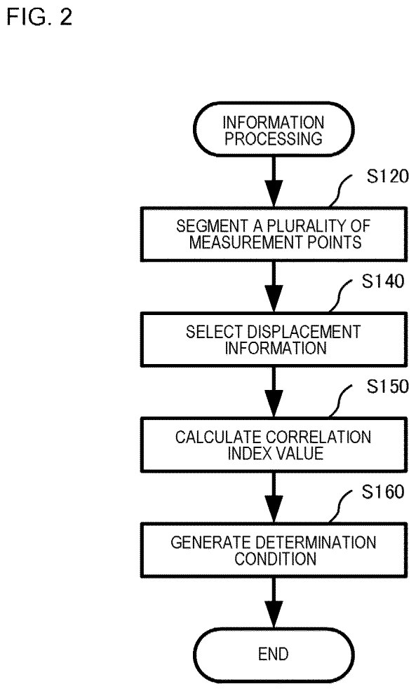

The information processing apparatus 100 according to the present disclosure executes information processing as illustrated in FIG. 2.

The segmentation unit 120 segments a plurality of measurement points for each segment of a construction in a two-dimensional image based on three-dimensional position information of the plurality of measurement points included in the construction (step S120).

The selection unit 140 selects a plurality of pieces of displacement information including displacement amounts of the plurality of measurement points included in a preset period and a set range for the construction (step S140).

The calculation unit 150 calculates a correlation index value representing a correlation for at least one of the segments included in the set range based on the selected displacement information and environment information indicating a state of an environment around the set range (step S150).

The generation unit 160 generates a determination condition for evaluating soundness of the construction for the at least one segment based on the index value of the at least one segment (step S160).

According to the information processing, a plurality of measurement points can be segmented for each segment of a construction, and a determination condition for the segment can be generated. It is possible to generate a determination condition capable of accurately evaluating soundness of a construction.

### Detailed Example

Hereinafter, detailed examples of the information processing apparatus 100 and a processing operation thereof are described.

The information processing apparatus 100 is a apparatus for evaluating soundness of a construction.

The construction has a structure supported by a foundation or the like and includes a plurality of materials, members, and the like. Examples of constructions may include bridges, roads, buildings, dams, banks, and facilities. Examples of the facility include airports, stations, harbors, and factories.

An object (to be evaluated) for evaluating soundness of a construction may be the entire construction or a part of the construction.

Generally, a construction may be deformed in accordance with a state of a surrounding environment. Therefore, the position of a point (for example, a measurement point) in the construction may be changed (be displaced) in accordance with the state of the surrounding environment. The state of the environment is, for example, at least one of a temperature, a precipitation amount, a snow accumulation amount, a solar radiation amount, a difference therebetween, and the like and is preferably represented using a value such as a numerical value or a level. Hereinafter, a value indicating the state of the environment is referred to as an environment state value. The state of the environment may further include at least one of an altitude, a distance from a coastline, a distance from a river, and the like.

The characteristic of displacement of the measurement point in the construction also changes due to deterioration of the construction. Therefore, for example, by using a value of an index (correlation index value) representing a correlation between a value based on a displacement amount at a measurement point and an environment state value of a surrounding environment of the measurement point, it is possible to evaluate soundness of the construction such as whether deterioration or the like has occurred in the construction and how much deterioration has occurred.

In the present example embodiment, an example in which the value based on the displacement amount is the displacement amount itself, and the environment state value is the air temperature difference is described.

The value based on the displacement amount is not limited to the displacement amount and may be, for example, a value that changes according to the displacement amount such as a corrected displacement amount and a parameter value of a displacement model described below in another example embodiment. The environment state value is not limited to the air temperature difference and may be, for example, a difference in solar radiation amount.

Meanwhile, characteristics of deformation or displacement of a construction vary depending on a structure, a material, or the like configuring the construction in many cases. Therefore, when the soundness of the construction is evaluated based on the displacement amount of the measurement point belonging to the portion (segment) having different displacement characteristics, the soundness can be more accurately evaluated by using the determination condition for each segment than by using the common determination condition.

In such a segment, for example, a portion having commonality or similarity in characteristics of deformation or displacement in accordance with the environment state may be set in the construction. The segment may be determined in advance as appropriate and the method of determining the segment is not limited to those exemplified here.

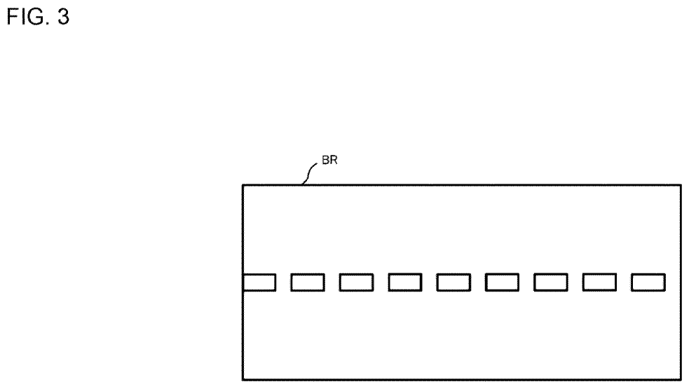

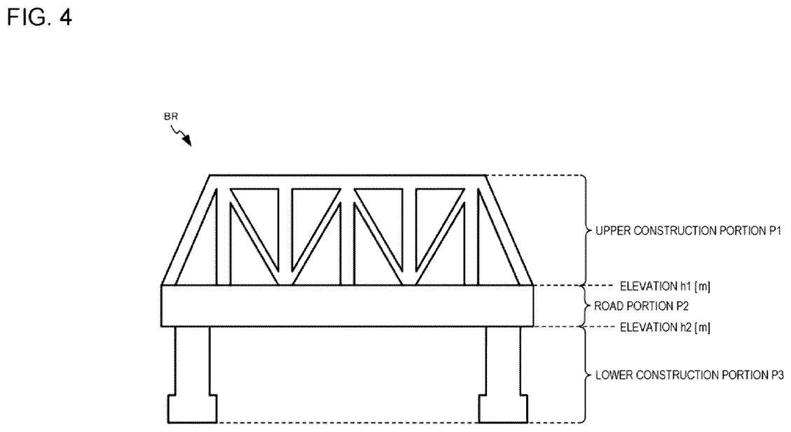

Hereinafter, a case where the construction to be evaluated is a bridge BR as illustrated in FIGS. 3 and 4, and the state of the environment is the temperature is described as an example. FIG. 3 is a diagram illustrating an example of the bridge BR to be evaluated as viewed from above. FIG. 4 is a diagram illustrating the example of the bridge BR to be evaluated as viewed from a side. In the bridge BR, for example, an upper construction portion P1, a road portion P2, and a lower construction portion P3 may be set as segments.

The road portion P2 is a segment in which a road is provided. The road portion P2 mainly includes, for example, a bridge beam and a road provided on the bridge beam. The bridge beam is mainly made of, for example, steel or concrete. The road is mainly made of, for example, asphalt.

The upper construction portion P1 and the lower construction portion P3 are segments configuring the upper side and the lower side of the road portion P2, respectively. The upper construction portion P1 has, for example, a truss structure using a steel frame as a main material. The lower construction portion P3 has a pillar structure mainly made of, for example, steel or concrete.

The segment related to the bridge BR is not limited to the segment exemplified here. For example, the segment may be defined by subdividing a part or all of the upper construction portion P1, the road portion P2, and the lower construction portion P3 into end portions within a predetermined range from the bridge end portion and a central portion between the end portions. For example, a combination of the road portion P2 and the lower construction portion P3 may be defined as one segment.

Various techniques may be used to measure the displacement amount of the measurement point in the construction. For example, the displacement amount may be measured using a sensor such as an acceleration sensor, a strain sensor, an image sensor, or an infrared sensor. However, in this case, it may not be easy to install the sensor, because a large number of sensors need to be installed, and time and effort for maintenance and inspection of the sensor increases. In addition, since the number and locations of sensors that can be actually installed are limited, when the soundness of the construction is evaluated using the measurement result, the accuracy of the evaluation may be deteriorated.

Therefore, remote sensing is suitable for measuring the displacement amount of the measurement point. Hereinafter, an example in which a synthetic aperture radar (SAR) is used for measuring a displacement amount of a measurement point is described.

In SAR, the ground is irradiated with a microwave from an antenna mounted on a flying object such as an artificial satellite or an aircraft, and measurement data (SAR image) is generated using a reflected wave from a construction to be evaluated.

The displacement amount is, for example, a movement amount of the measurement point along an irradiation direction (line-of-sight direction) of the radar from the flying object toward the measurement point. Such a displacement amount is generated, for example, by interference processing using phase information included in a SAR image pair obtained by measuring a construction to be evaluated at different timings.

Specifically, for example, the displacement amount at a timing ti is generated by interference processing between the SAR image based on the measurement of a predetermined reference timing t0 and the SAR image based on the measurement of the timing ti. The reference timing t0 is, for example, a timing when the construction is completed or a timing when it can be considered that there is no abnormality in the construction. i is an integer of one or more and equal to or less than n, and n is an integer of one or more. The reference timing to and the plurality of timings t1 to tn may be predetermined time intervals such as two weeks, three months, and one year. Each of the reference timing t0 and the timings t1 to tn may be appropriately determined in advance and is not limited to those exemplified here.

### (Detailed Example of Information Processing Apparatus 100)

### (Detailed Functional Configuration Example of Information Processing Apparatus 100)

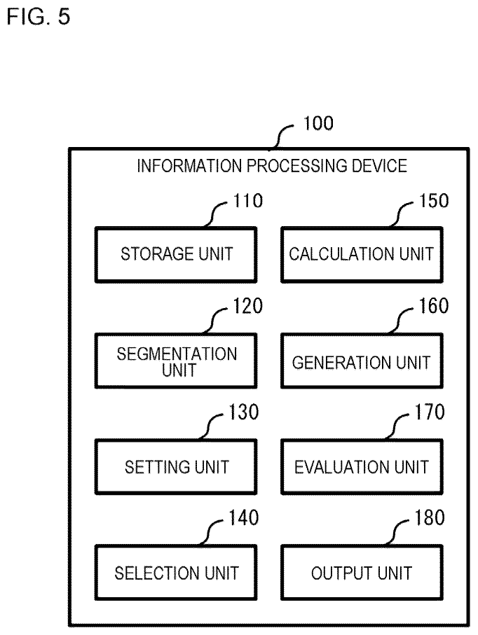

For example, as illustrated in FIG. 5, the information processing apparatus 100 may include a storage unit 110, the segmentation unit 120, a setting unit 130, the selection unit 140, the calculation unit 150, the generation unit 160, an evaluation unit 170, and an output unit 180.

### (Storage Unit 110)

The storage unit 110 stores various pieces of information.

The storage unit 110 stores, for example, measurement point information and construction information in advance.

The measurement point information is information on a plurality of measurement points at each measurement timing (for example, the reference timing t0 and the timings t1 to tn) of the bridge BR. For example, the measurement point information may include at least one of measurement data, measurement point position information, displacement information, and the like at each measurement timing.

The measurement data may include, for example, a SAR image.

The measurement point position information may include, for example, the position of each measurement point. The position included in the measurement point position information may be represented by a position in the SAR image that is a two-dimensional image. Specifically, for example, the position included in the measurement point position information may be represented using a two-dimensional coordinate system with a predetermined position in the SAR image as an origin.

The displacement information may include, for example, a displacement amount of each measurement point. As described above, the displacement amount is, for example, a movement amount of the measurement point along an irradiation direction (line-of-sight direction) of the radar from the flying object toward the measurement point.

The measurement point information is not limited to the information exemplified here and may include, for example, measurement point identification information for identifying each measurement point.

The construction information is information on the bridge BR to be evaluated. The construction information may include, for example, at least one of construction position information, segment setting information, and the like.

The construction position information is, for example, information that can three-dimensionally specify a position of an optional point on the bridge BR. Specifically, for example, the construction position information may include at least one of representative position information, structure dimension information, and the like.

The representative position information is information indicating positions of one or a plurality of predetermined representative points for the bridge BR. The position indicated by the representative position information is represented in three dimensions using, for example, latitude, longitude, and altitude. The method of representing the position in three dimensions is not limited to that exemplified herein.

The construction dimension information is information including a dimension of the bridge BR. The construction dimension information may include, for example, dimensions of one or a plurality of predetermined locations of the bridge BR. The location may be an overall dimension of the bridge BR or a partial dimension of the bridge BR.

The construction information is not limited to those exemplified here and may include, for example, at least one of construction identification information for identifying a construction, structure information indicating a structure of a construction, and the like. For example, the structure information may include at least one of structure type information, material type information, member identification information, member dimension information, member position information, and the like. The structure type information is, for example, information indicating a type (for example, a truss structure, a columnar shape, or a box shape) of a structure of each unit configuring a construction. The material type information is, for example, information indicating a main material configuring a construction. The material type information is information for identifying members configuring a construction. The member dimension information is information indicating dimensions of members configuring the construction. The member position information is information indicating positions of members configuring the construction. The structure type information, the material type information, the member identification information, the construction dimension information, the member dimension information, the member position information, and the like may be associated with the segment using, for example, segment identification information described below.

The segment setting information is information for specifying at least one segment related to the bridge BR. The segment setting information is set, for example, by the user. In the present example embodiment, for example, three segments of the upper construction portion P1, the road portion P2, and the lower construction portion P3 are set as described above for the bridge BR. The segment setting information in this case may be information for specifying each segment (each of the upper construction portion P1, the road portion P2, and the lower construction portion P3) set by the user. Specifically, for example, each segment may be segmented by an elevation. The segment setting information in this case may include the elevation in accordance with each segment. For example, the segment setting information may include that the upper construction portion P1 is a portion having an elevation higher than h1 [m], the road portion P2 is a portion having an elevation equal to or lower than h1 [m] and higher than h2 [m], and the lower construction portion P3 is a portion having an elevation equal to or lower than h2 [m].

The segment setting information is not limited to that exemplified here. For example, the segment setting information may include a combination of an elevation related to each segment and a horizontal distance or region. For example, the segment setting information may include one or a plurality of combinations of members, portions, and the like configuring a construction.

The storage unit 110 may store, for example, at least one of setting information, environment information, index information, determination condition information, and the like.

The setting information may include, for example, period information indicating a period set by the user and range information indicating a set range by the user. The range information is, for example, information indicating a set range for the construction and may be represented in three dimensions using latitude, longitude, altitude, and the like.

The set range for the construction may include, for example, a first range and a second range. The first range is a range to be evaluated. The second range is a range for generating a determination condition. At least one second range or the plurality of second ranges may be set. That is, the set range may include the plurality of first ranges to be evaluated and at least one second range for generating a determination condition.

In the following description, an example in which the second range is included in the same bridge BR as the first range is described, but the second range may be set for a construction different from the first range. In this case, the second range may be set to, for example, a construction having a structure similar to the construction (this is the construction to be evaluated and is the bridge BR in the present example embodiment.) in which the first range is set.

The environment information is information including an environment state value. The environment information includes, for example, a temperature around the bridge BR. The environment information may include, for example, a temperature in accordance with each measurement period (for example, the reference timing t0 and the timings t1 to tn). The environment information may include, for example, an air temperature difference in accordance with each of the timings t1 to tn. The air temperature difference in accordance with the timing ti may be a difference ΔTi (for example, ΔTi=Ti−T0) between an air temperature T0 that is the environment state value at the reference timing t0 and an air temperature Ti that is the environment state value at the time ti.

The environment information may be acquired from an external server apparatus or the like that provides weather information, for example, using a communication unit (not illustrated) of the information processing apparatus 100. The communication unit is, for example, a processing unit that transmits and receives information to and from an external server apparatus or the like via a wired or wireless communication network or a combination thereof. For example, when the environment information includes a temperature difference, and an external server apparatus or the like provides the current or past temperature, the communication unit may perform calculation for generating the environment information. For example, the communication unit may calculate the temperature difference using the temperature acquired from an external server apparatus or the like and the temperature at the reference timing t0 and store the environment information including the calculated temperature difference in the storage unit 110.

The index information is information including the calculated correlation index value. The correlation index value may include a first index value and a second index value. The first index value is a correlation index value calculated for each segment included in the first range. The second index value is a correlation index value calculated for each segment included in the second range.

As described above, one or more segments and second ranges may be provided. That is, the correlation index value may include the plurality of first index values for at least one segment included in the first range and the second index value for at least one segment included in the at least one second range.

The determination condition information is information including the generated determination condition. For example, as described below, the determination condition of the associated segment is generated based on the second index value of each segment. As described above, since the second index value is calculated according to the segment included in the second range, one or more second index values may be provided. That is, the determination condition for at least one segment is generated based on the second index value for the at least one associated segment.

Although FIG. 5 illustrates an example in which the information processing apparatus 100 includes the storage unit 20, some or all of the information stored in the storage unit 20 may be stored in a storage unit provided in an external apparatus different from the information processing apparatus 100. In this case, the information processing apparatus 100 and the external apparatus may be connected in such a way as to be able to transmit and receive information to and from each other, for example, via wired or wireless communication network or a combination thereof. Then, the information processing apparatus 100 may acquire information stored in a storage unit included in an external apparatus, for example, via a communication network or may store various types of information acquired by setting, generation, calculation, or the like in the information processing apparatus 100 in a storage unit included in an external apparatus.

### (Segmentation Unit 120)

The segmentation unit 120 segments a plurality of measurement points for each segment of the bridge BR, for example, based on three-dimensional position information of the plurality of measurement points included in the bridge BR in the SAR image that is a two-dimensional image. The SAR image here may be, for example, a two-dimensional image of the bridge BR viewed from above as illustrated in FIG. 3.

For example, using the SAR image and the construction position information stored in advance in the storage unit 110, the segmentation unit 120 generates three-dimensional positional information of the plurality of measurement points from two-dimensional positions of the plurality of measurement points included in the bridge BR in the SAR image. The three-dimensional position information is information three-dimensionally indicating positions of a plurality of measurement points.

For example, the segmentation unit 120 segments a plurality of measurement points into each segment (for example, the upper construction portion P1, the road portion P2, and the lower construction portion P3) of the bridge BR using the segment setting information and three-dimensional position information of the plurality of measurement points stored in advance in the storage unit 110.

For example, the segmentation unit 120 specifies the three-dimensional position of the measurement point using the three-dimensional position information and specifies to which segment the three-dimensional position belongs using the segment setting information. By executing such processing for each of the plurality of measurement points, the plurality of measurement points are segmented for each segment. The method of segmenting the plurality of measurement points for each segment is not limited to the method exemplified here.

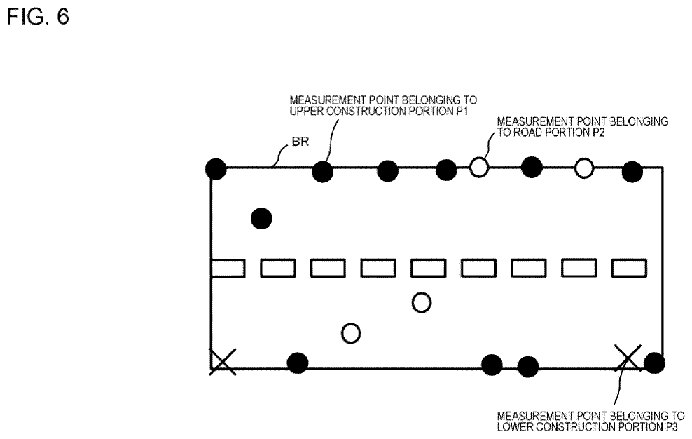

FIG. 6 is a diagram illustrating an example in which the plurality of measurement points included in a construction in a two-dimensional image are segmented for each segment. This drawing illustrates an example in which the plurality of measurement points included in the bridge BR in the SAR image are segmented into the upper construction portion P1, the road portion P2, and the lower construction portion P3. The measurement points segmented into the upper construction portion P1 are indicated by white circles. The measurement points segmented into the road portion P2 are indicated by solid circles. The measurement points segmented into the lower construction portion P3 are indicated by X.

The segment setting information may not be stored in the storage unit 110 in advance, and the segmentation unit 120 may generate the segment setting information according to designation by a user. At this time, for example, the segmentation unit 120 may generate segment setting information for specifying each segment by receiving designation of an elevation in association with each segment of the bridge BR. The segment information in this case may include the elevation designated for each segment. For example, the segmentation unit 120 may generate segment setting information for specifying each segment by receiving designation of a structure, a portion, and the like in each segment of the bridge BR. The portion configuring the segment may be designated, for example, by displaying a three-dimensional image of the bridge BR on the output unit 180 described below and designating a member, a region, and the like with respect to the three-dimensional image. The segmentation unit 120 may store the generated segment setting information in the storage unit 110.

### (Setting Unit 130)

The setting unit 130 receives, for example, designation of a period and a range related to the bridge BR to be evaluated from the user. For example, the setting unit 130 stores each of the designated period and range in the storage unit 110 as the period information and the range information. The set range for the bridge BR may include, for example, a first range and at least one second range.

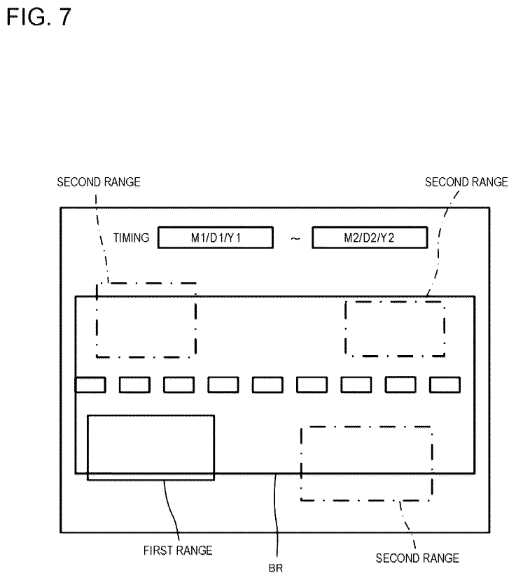

FIG. 7 is a diagram illustrating a configuration example of a screen for the user to designate a period and a range. For example, as illustrated in FIG. 7, the setting unit 130 receives designation of the start and the end of the period from the user.

For example, the SAR image that is the two-dimensional image of the bridge BR to be evaluated is displayed on output unit 180 described below. As illustrated in FIG. 7, for example, the setting unit 130 receives designation of each of the first range and the second range in the two-dimensional image of the bridge BR. The drawing illustrates an example in which one first range and three second ranges are designated in a rectangular range.

The shape of the designated range is not limited to a rectangular shape and may be an appropriate shape. The number of the designated first ranges is not limited to one and may be plural. The number of the designated second ranges may be one or more and is not limited to three.

### (Selection Unit 140)

For example, the selection unit 140 selects a plurality of pieces of displacement information including a displacement amount of each of a plurality of measurement points included in a preset period and a set range for the bridge BR from among pieces of displacement information stored in advance in the storage unit 110.

Specifically, for example, the selection unit 140 selects a plurality of pieces of displacement information from the pieces of displacement information stored in advance in the storage unit 110 by using the period information and the range information set by the setting unit 130 and stored in the storage unit 110. The plurality of pieces of selected displacement information is displacement information in which the measurement timing included in the period indicated by the period information is associated with the position of the measurement point included in the range indicated by the range information in the measurement point information stored in advance in the storage unit 110.

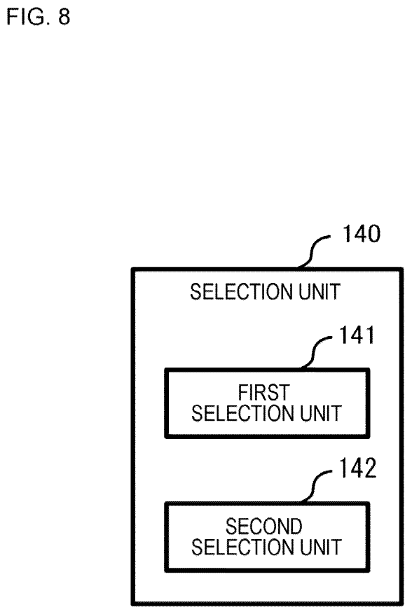

For example, as illustrated in FIG. 8, the selection unit 140 may include a first selection unit 141 and a second selection unit 142. The first selection unit 141 and the second selection unit 142 select a plurality of pieces of displacement information related to the first range and the second range, respectively.

For example, the first selection unit 141 selects, as the plurality of pieces of first displacement information, a plurality of pieces of displacement information including a displacement amount of each of a plurality of measurement points included in a preset period and a first range set for the bridge BR from among pieces of displacement information stored in advance in the storage unit 110.

For example, the second selection unit 142 selects, as the plurality of pieces of second displacement information, a plurality of pieces of displacement information including a displacement amount of each of a plurality of measurement points included in a preset period and a second range set for the bridge BR from among pieces of displacement information stored in advance in the storage unit 110.

### (Calculation Unit 150)

The calculation unit 150 calculates a correlation index value representing a correlation for at least one of the segments included in the set range, for example, based on the selected displacement information and environment information indicating a state of an environment around the set range.

The correlation index value is a value of an index (correlation index) representing a correlation between a value (displacement amount in the present example embodiment) based on the displacement amount included in the plurality of pieces of selected displacement information and the environment state value of the environment surrounding the measurement point.

The correlation index value is, for example, a correlation coefficient. The correlation index value in this case is, for example, a value obtained by dividing the covariance of a variable X and a variable Y by the product of the standard deviation of the variable X and the standard deviation of the variable Y. Here, as the variable X, a value based on the displacement amount (displacement amount in the present example embodiment) may be used. An environment state value may be used as the variable Y.

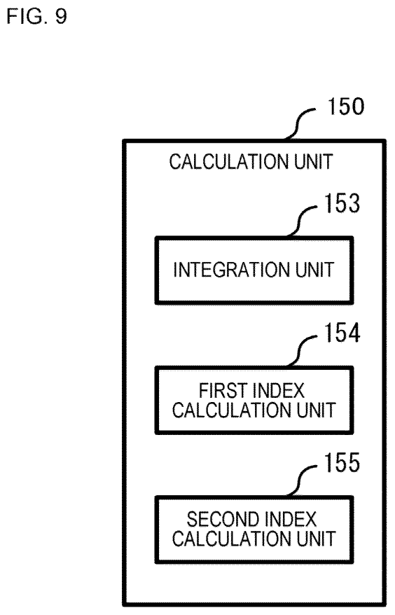

For example, as illustrated in FIG. 9, the calculation unit 150 may include an integration unit 153, a first index calculation unit 154, and a second index calculation unit 155.

The integration unit 153 integrates displacement information including a displacement amount of the measurement point included in the second range in the period for each segment and generates integrated displacement information including the displacement amount of the measurement point for each segment. Here, the second range to be set may be one. That is, the integration unit 153 integrates displacement information including a displacement amount of the measurement point included in at least one second range in the period for each segment and generates integrated displacement information including the displacement amount of the measurement point for each segment.

The integrated displacement information can also be said to be information reconfigured in such a way that the displacement information of the measurement points included in the second range is grouped for each segment. For example, integrated displacement information in association with each segment of the upper construction portion P1, the road portion P2, and the lower construction portion P3 is generated. Each integrated displacement information includes one or a plurality of pieces of displacement information.

The first index calculation unit 154 calculates the first index value for each segment to which the measurement point included in the first range belongs based on the displacement information of the measurement point included in the first range in the period and the environment information. Here, the measurement points included in the first range may belong to all or some of the plurality of segments or may belong to only one segment. That is, the first index calculation unit 154 calculates the first index value for at least one segment based on the displacement information of the measurement points included in the first range in the period and the environment information.

The second index calculation unit 155 calculates the second index value for each segment based on the integrated displacement information for each segment in the period and the environment information. Here, the second index calculation unit 155 may calculate at least the second index value of the segment for which the first index value has been calculated. That is, the second index calculation unit 155 calculates the second index value for at least one segment based on the integrated displacement information for each segment in the period and the environment information.

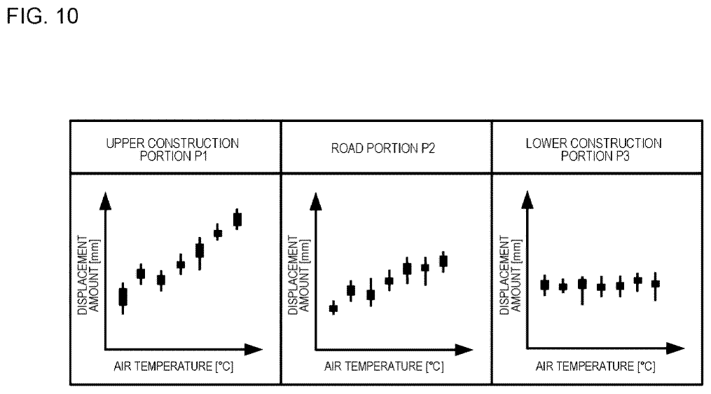

FIG. 10 is a diagram illustrating an example of a box-and-whisker diagram illustrating the correlation between the displacement amount and the environment state value (in the present example embodiment, the air temperature difference). This drawing is a box-and-whisker diagram illustrating the correlation between the displacement amount and the environment state value for each segment to which the measurement point included in the second range belongs and is associated with the section of the measurement point illustrated in FIG. 6. In the example of FIG. 10, a positive correlation is shown for each of the upper construction portion P1 and the road portion P2.

### (Generation Unit 160)

For example, the generation unit 160 generates a determination condition for evaluating the soundness of the construction for each segment based on the second index value for each segment. The generation unit 160 generates the determination condition of the segment in association with each of the second index values based on each of the second index values. For example, it is assumed that the second index value is calculated for each of the upper construction portion P1, the road portion P2, and the lower construction portion P3. The generation unit 160 generates a determination condition of the upper construction portion P1 based on the second index value of the upper construction portion P1. The generation unit 160 generates a determination condition of the road portion P2 based on the second index value of the road portion P2. The generation unit 160 generates a determination condition of the lower construction portion P3 based on the second index value of the lower construction portion P3.

Here, the second index value for one segment may be calculated, and the determination condition for the one segment may be generated based on the second index value. The second index values for the plurality of segments may be calculated, and the determination condition for the plurality of segments may be generated based on each of the plurality of second index values. That is, the generation unit 160 may generate a determination condition for evaluating soundness of the construction for the at least one segment based on the correlation index value of the at least one segment. In addition, the determination condition for the at least one segment may be generated based on the second index value for the at least one segment.

The determination condition may include, for example, an upper limit and a lower limit of a value range that can be taken by the second index value when the construction (the bridge BR in the present example embodiment) in which the second range is set is normal. The upper limit and the lower limit of the value range may be calculated by the generation unit 160 based on the statistical value (for example, an average value and a standard deviation) of the second index value or may be the average value±1.5×the standard deviation. This is an example of a determination condition based on the concept of statistics referred to as a confidence interval. The determination conditions are not limited to those exemplified here, and for example, the numerical value of 1.5 may be appropriately changed.

### (Evaluation Unit 170)

The evaluation unit 170 evaluates the soundness of each segment, for example, using the determination condition for the each segment. Then, the evaluation unit 170 generates, for example, information indicating the evaluation result of each segment.

For example, the evaluation unit 170 evaluates the soundness of each segment included in the first range by using the determination condition for each segment and the first index value. In the evaluation of the soundness of each segment, for example, the determination condition and the first index value for the associated segment are used.

Here, a determination condition for one or a plurality of segments may be generated. That is, the evaluation unit 170 may evaluate the soundness of the construction using the determination condition for at least one segment. The number of segments to which the measurement points included in the first range belong may be plural or one. That is, the soundness of the construction may be evaluated using the determination condition for the associated segment for each of at least one segment included in the first range.

The result of the evaluation may include, for example, whether it is normal. For example, when the determination condition includes the upper limit and the lower limit of the value range as described above, if the first index value is within the range of the upper limit and the lower limit, the evaluation unit 170 may evaluate that the segment in association with the first index value is normal. For example, when the first index value is out of the range of the upper limit and the lower limit, the evaluation unit 170 may evaluate that the segment in association with the first index value is not normal (or is abnormal). The result of the evaluation is not limited to the above example. For example, when the value is not normal, the evaluation unit 170 may generate a value indicating a degree (level) of abnormality as the evaluation result according to the magnitude of the difference between the first index value and the upper limit or the lower limit of the value range included in the determination condition.

### (Output Unit 180)

The output unit 180 outputs various types of information. The output unit 180 displays, for example, various types of information.

The various types of information may include, for example, one or a plurality of pieces of information stored in the information processing apparatus 100, information acquired by setting, generation, calculation, or the like in the information processing apparatus 100, and the like. For example, the information output (displayed) by the output unit 180 may include a SAR image including the bridge BR to be evaluated, the first range and the second range set for the SAR image, and measurement points included in each of the ranges. For example, the information output (displayed) by the output unit 180 may include a determination condition for each segment, a first index value for each segment, a result of evaluation for each segment, and the like. The information output (displayed) by the output unit 180 may be one or a plurality of pieces of the information exemplified here.

The method by which the output unit 180 outputs information is not limited to display. The output unit 180 may transmit various types of information to another apparatus. The other apparatus may be, for example, a terminal apparatus used by the user, a server apparatus or the like that receives and manages transmitted information or uses the transmitted information, or a display or the like provided outside the information processing apparatus 100.

### (Detailed Processing Operation Example of Information Processing Apparatus 100)

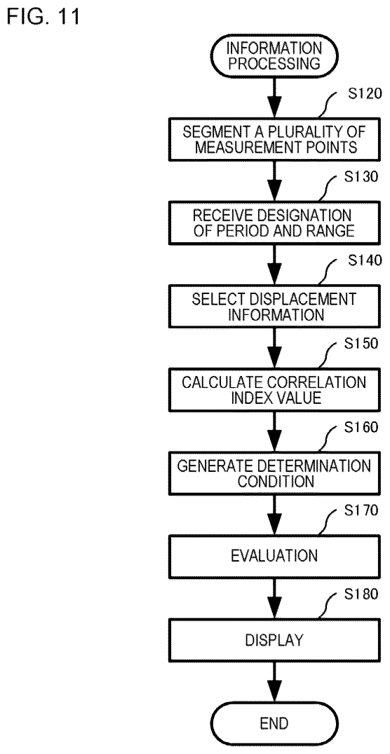

The information processing apparatus 100 may execute information processing as illustrated in FIG. 11. This information processing is started, for example, when measurement point information, construction information, and the like are stored in the storage unit 110 in advance, and a predetermined instruction is received from the user. The trigger for starting the information processing is not limited thereto.

As described above, the segmentation unit 120 segments the plurality of measurement points for each segment of the construction based on the three-dimensional position information of the plurality of measurement points included in the construction in the two-dimensional image (step S120).

The setting unit 130 receives designation of a period and a range for the bridge BR to be evaluated (step S130).

As described above, the selection unit 140 selects a plurality of pieces of displacement information including displacement amounts of the plurality of measurement points included in a preset period and a set range for the construction (step S140).

As described above, the calculation unit 150 calculates the correlation index value representing the correlation for at least one segment included in the set range based on the selected displacement information and the environment information indicating the state of the environment around the set range (step S150).

As described above, the generation unit 160 generates a determination condition for evaluating soundness of the construction for the at least one segment based on the index value of the at least one segment (step S160).

The evaluation unit 170 evaluates the soundness of the construction using the determination condition for at least one segment (step S170).

The output unit 180 displays the evaluation result and the like (step S180).

Details of processes may be processes associated with the functions described above for the functional units (the segmentation unit 120, the setting unit 130, the selection unit 140, the calculation unit 150, the generation unit 160, the evaluation unit 170, and the output unit 180) that execute the processes.

### (Physical Configuration Example of Information Processing Apparatus 100)

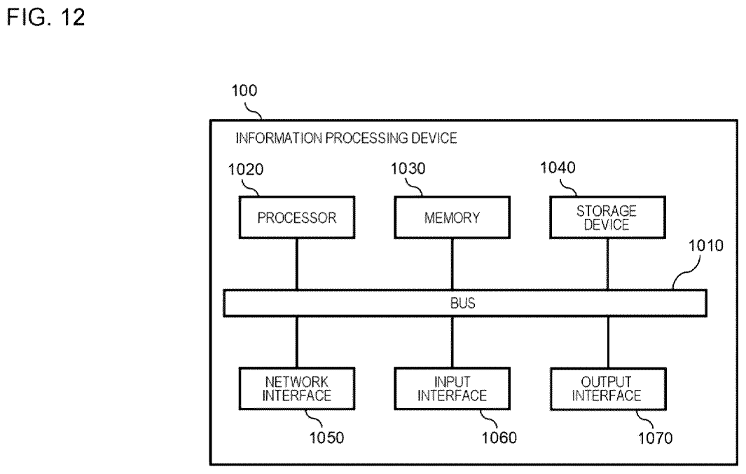

As illustrated in FIG. 12, an information processing apparatus 100 physically includes, for example, a bus 1010, a processor 1020, a memory 1030, a storage apparatus 1040, a network interface 1050, an input interface 1060, and an output interface 1070.

The bus 1010 is a data transmission path through which the processor 1020, the memory 1030, the storage apparatus 1040, the network interface 1050, the input interface 1060, and the output interface 1070 transmit and receive data to and from each other. However, the method of connecting the processor 1020 and the like to each other is not limited to bus connection.

The processor 1020 is a processor achieved by a central processing unit (CPU), a graphics processing unit (GPU), or the like.

The memory 1030 is a main storage apparatus achieved by a random access memory (RAM) or the like.

The storage apparatus 1040 is an auxiliary storage apparatus achieved by a hard disk drive (HDD), a solid state drive (SSD), a memory card, a read only memory (ROM), or the like. The storage apparatus 1040 stores a program module for achieving the function of the information processing apparatus 100 including the storage apparatus 1040. The processor 1020 achieves the functions associated with the program modules by reading and executing the program module in the memory 1030.

The network interface 1050 is an interface for connecting the information processing apparatus 100 including the network interface 1050, to the network NT.

The input interface 1060 is an interface for the user to input information. The input interface 1060 is configured with, for example, a touch panel, a keyboard, and a mouse.

The output interface 1070 is an interface for presenting information to the user. The output interface 1070 is configured with, for example, a liquid crystal panel or an organic electro-luminescence (EL) panel.

The physical configuration of the information processing apparatus 100 is not limited thereto. For example, the information processing apparatus 100 may include a plurality of apparatus. Each apparatus in this case may be, for example, a computer having a configuration physically similar to that of the information processing apparatus 100 illustrated in FIG. 12.

### (Operation and Effect)

As described above, according to the present example embodiment, the information processing apparatus 100 includes the segmentation unit 120, the selection unit 140, the calculation unit 150, and the generation unit 160.

The segmentation unit 120 segments a plurality of measurement points for each segment of a construction in a two-dimensional image based on three-dimensional position information of the plurality of measurement points included in the construction. The selection unit 140 selects a plurality of pieces of displacement information including displacement amounts of the plurality of measurement points included in a preset period and a set range for the construction. The calculation unit 150 calculates a correlation index value representing a correlation for at least one of the segments included in the set range based on the selected displacement information and environment information indicating a state of an environment around the set range. The generation unit 160 generates a determination condition for evaluating soundness of the construction for the at least one segment based on the index value of the at least one segment. According to this, a plurality of measurement points can be segmented for each segment of a construction, and a determination condition for the segment can be generated. It is possible to generate a determination condition capable of accurately evaluating soundness of a construction.

According to the present example embodiment, the information processing apparatus 100 includes the evaluation unit 170 that evaluates the soundness of the construction using the determination condition for at least one segment. The set range includes the plurality of first ranges to be evaluated and at least one second range for generating a determination condition. The correlation index value includes the plurality of first index values for at least one segment included in the first range and the second index value for at least one segment included in the at least one second range. The determination condition for at least one segment is generated based on the second index value for the at least one segment. The soundness of the construction is evaluated using the determination condition for the associated segment for each of at least one segment included in the first range.

According to this, the soundness of each segment to which the measurement point included in the first range belongs can be evaluated using the determination condition generated based on the second index value. It is possible to accurately evaluate soundness of a construction.

According to the present example embodiment, the calculation unit 150 includes the integration unit 153, the first index calculation unit 154, and the second index calculation unit 155.

The integration unit 153 integrates displacement information including a displacement amount of the measurement point included in at least one second range in the period for each segment and generates integrated displacement information including the displacement amount of the measurement point for each segment. The first index calculation unit 154 calculates the first index value for at least one segment based on the displacement information of the measurement points included in the first range in the period and the environment information. The second index calculation unit 155 calculates the second index value for at least one segment based on the integrated displacement information for each segment in the period and the environment information.

Accordingly, the determination condition for each segment can be generated based on the second index value. It is possible to generate a determination condition capable of accurately evaluating soundness of a construction.

The soundness of each segment to which the measurement point included in the first range belongs can be evaluated using this determination condition. It is possible to accurately evaluate soundness of a construction.

### Second Example Embodiment

In the first example embodiment, an example in which the value based on the displacement amount used for calculation in the correlation index value is the displacement amount is described. In the present example embodiment, an example in which a value based on the displacement amount is a corrected displacement amount obtained by correcting the displacement amount using a displacement model is described.

### (Functional Configuration Example of Information Processing Apparatus 200)

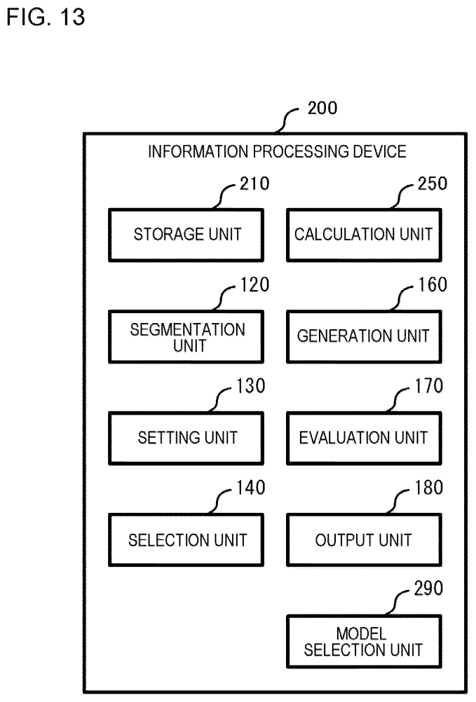

For example, as illustrated in FIG. 13, an information processing apparatus 200 includes a storage unit 210 and a calculation unit 250 instead of the storage unit 110 and the calculation unit 150. The information processing apparatus 200 further includes, for example, the segmentation unit 120, the setting unit 130, the selection unit 140, the generation unit 160, the evaluation unit 170, and the output unit 180 similar to those described above. The information processing apparatus 200 further includes, for example, a model selection unit 290.

### (Storage Unit 210)

The storage unit 210 may store, for example, information stored in the storage unit 110 described above. The storage unit 210 may further store, for example, displacement model information including a displacement model in advance.

The displacement model is a model representing a relationship between displacement information (for example, the displacement amount) and environment information (for example, the environment state value). The displacement model may be a mathematical model represented using a linear formula, a piecewise linear form, a polynomial, an exponential function, a trigonometric function, or the like. The displacement model may include one or a plurality of parameters.

This mathematical model may be created by various methods. For example, the mathematical model may be created based on an experimental result, may be created based on a simulation result, or may be theoretically created. The mathematical model may be created using machine learning

The plurality of displacement models may be provided. The plurality of displacement models may include different displacement models in accordance with the type of the segment. For example, it is assumed that the segments are the upper construction portion P1, the road portion P2, and the lower construction portion P3, the upper construction portion P1 has a truss structure, the road portion P2 has a box-shaped structure, and the lower construction portion P3 has a columnar structure. The plurality of displacement models may include displacement models in accordance with various structures such as a truss structure, a box-shaped structure, and a columnar structure. The plurality of displacement models is not limited to different displacement models associated with the structure and may include, for example, displacement models associated with various application conditions. The application condition may include, for example, one or a plurality of elements related to a characteristic of the construction such as a structure and a material.

### (Model Selection Unit 290)

The model selection unit 290 selects a displacement model representing a relationship between displacement information and environment information based on structure information indicating a structure of a construction.

For example, the model selection unit 290 selects the displacement model based on the structure information of the bridge BR that is the construction in which the first range and the second range are set. For example, the model selection unit 290 may select the displacement model to be applied for each segment based on the structure information of the bridge BR and the application condition associated with the displacement model.

Specifically, for example, it is assumed that the structural information related to each segment of the bridge BR includes a truss structure, a box-shaped structure, and a columnar structure for each of the upper construction portion P1, the road portion P2, and the lower construction portion P3. It is assumed that a plurality of pieces of displacement model information including each of the truss structure, the box-shaped structure, and the columnar structure as the application condition is stored in the storage unit 210.

In this case, the model selection unit 290 may select the displacement model information including the truss structure as the application condition, that is, the displacement model associated with the application condition including the truss structure, for the upper construction portion P1. Similarly, the model selection unit 290 may select the displacement model associated with the application condition including a box-shaped structure for the road portion P2. The model selection unit 290 may select the displacement model associated with the application condition including a columnar structure for the lower construction portion P3.

The method by which the model selection unit 290 selects the displacement model is not limited to the method exemplified here.

### (Calculation Unit 250)

For example, the calculation unit 250 generates the corrected displacement information using the selected displacement model and the displacement information in the set range in the period and calculates the correlation index value based on the corrected displacement information and the environment information.

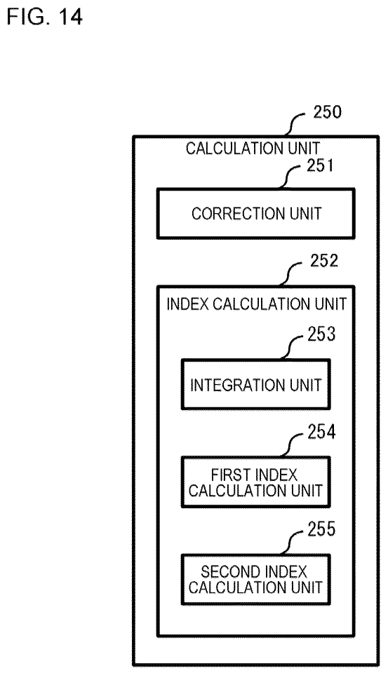

For example, as illustrated in FIG. 14, the calculation unit 250 includes a correction unit 251 and an index calculation unit 252. The index calculation unit 252 includes an integration unit 253, a first index calculation unit 254, and a second index calculation unit 255 instead of the integration unit 153, the first index calculation unit 154, and the second index calculation unit 155.

### (Correction Unit 251)

The correction unit 251 generates the corrected displacement information, for example, using the selected displacement model and the displacement information in the set range in the period. The corrected displacement information includes, for example, a corrected displacement amount obtained by correcting the displacement amount included in the displacement information using the selected displacement model.

For example, the correction unit 251 determines the value of the parameter included in the displacement model of the corresponding segment by using the displacement amount of the measurement point of each segment included in the first range in the set period and the environment state value (for example, a temperature difference) at an associated timing. For example, the correction unit 251 determines the parameter included in the displacement model of the corresponding segment by using the displacement amount of the measurement point of each segment included in the second range in the set period and the environment state value (for example, a temperature difference) at an associated timing.

At this time, the correction unit 251 may determine the parameter included in the displacement model, for example, using a least squares method or the like. The method of determining the value of the parameter included in the displacement model is not limited to the least squares method.

For example, the correction unit 251 calculates a corrected displacement amount obtained by correcting the displacement amount of the measurement point belonging to the corresponding segment using the displacement model of each segment for which the parameter has been determined. For example, the correction unit 251 calculates the corrected displacement amount by substituting the environmental state value (for example, a temperature difference) corresponding to the measurement point into the displacement model for which the parameter has been determined.

### (Index Calculation Unit 252)

The index calculation unit 252 calculates the correlation index value based on the corrected displacement information in the set range in the period and the environment information indicating the state of the environment around the set range. As described above, the index calculation unit 252 may include the integration unit 253, the first index calculation unit 254, and the second index calculation unit 255.

The integration unit 253 uses the corrected displacement amount instead of the displacement amount used by the integration unit 153 described above. The first index calculation unit 254 uses corrected displacement information (corrected displacement amount) instead of the displacement information (displacement amount) used by the first index calculation unit 154 described above. The second index calculation unit 255 uses the integrated displacement information generated using the corrected displacement amount as the integrated displacement information used by the first index calculation unit 154 described above.

Except for these points, the integration unit 253, the first index calculation unit 254, and the second index calculation unit 255 may have functions similar to those of the integration unit 153, the first index calculation unit 154, and the second index calculation unit 155.

Although the example of calculating the corrected displacement amount obtained by correcting the displacement amount of the measurement point included in the first range and the second range is described here, the corrected displacement amount may be calculated only for the measurement point included in one of the first range and the second range. In addition, when the plurality of second ranges are set, the value of the parameter included in the displacement model of each segment may be determined for each second range, or the values of the parameter included in the displacement model of each segment may be determined by integrating the plurality of second ranges. For example, when the corrected displacement amount is calculated only in the first range, the index calculation unit 252 may include the integration unit 153 and the second index calculation unit 155 that use the uncorrected displacement amount in the second range in which the corrected displacement amount is not calculated. For example, when the corrected displacement amount is calculated only in the second range, the index calculation unit 252 may include the first index calculation unit 154 that uses the uncorrected displacement amount in the first range in which the corrected displacement amount is not calculated.

### (Detailed Processing Operation Example of Information Processing Apparatus 200)

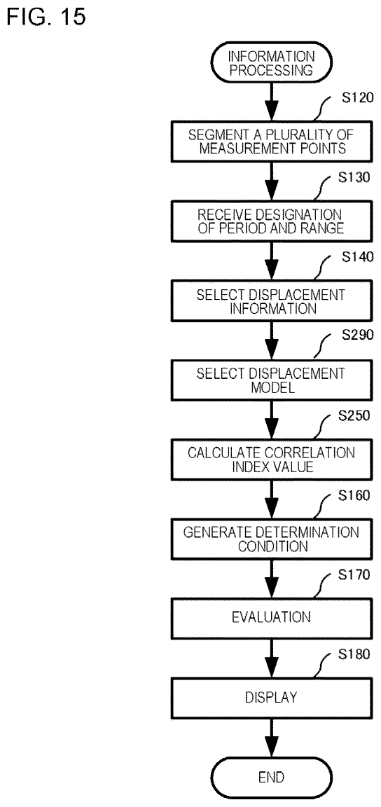

The information processing apparatus 200 may execute information processing as illustrated in FIG. 15. This information processing is started, for example, when measurement point information, construction information, and the like are stored in the storage unit 210 in advance, and a predetermined instruction is received from the user. The trigger for starting the information processing is not limited thereto.

Steps S120, S130, and S140 similar to those described above are executed.

The model selection unit 290 selects a displacement model representing a relationship between displacement information and environment information based on structure information indicating a structure of a construction (step S290).

The calculation unit 250 generates the corrected displacement information using the selected displacement model and the displacement information in the set range in the period and calculates the correlation index value based on the corrected displacement information and the environment information (step S250).

Steps S160, S170, and S180 similar to those described above are executed.

Details of processes may be processes associated with the functions described above for the functional units (the segmentation unit 120, the setting unit 130, the selection unit 140, the model selection unit 290, the calculation unit 250, the generation unit 160, the evaluation unit 170, and the output unit 180) that execute the processes.

### (Operation and Effect)

As described above, according to the present example embodiment, the information processing apparatus 200 includes the model selection unit 290 that selects the displacement model representing the relationship between the displacement information and the environmental information based on the structure information indicating the structure of the construction.

The calculation unit 250 includes the correction unit 251 and the index calculation unit 252. The correction unit 251 generates the corrected displacement information using the selected displacement model and the displacement information in the set range in the period. The index calculation unit 252 calculates the correlation index value based on the corrected displacement information in the set range in the period and the environment information indicating the state of the environment around the set range.

Accordingly, the soundness of the construction can be evaluated using the corrected displacement amount obtained by correcting the measured displacement amount. It is possible to accurately evaluate soundness of a construction.

According to the present example embodiment, the corrected displacement information includes a corrected displacement amount obtained by correcting the displacement included in the displacement information using the selected displacement model.

Accordingly, the soundness of the construction can be evaluated using the corrected displacement amount obtained by correcting the measured displacement amount. It is possible to accurately evaluate soundness of a construction.

### First Modification

In the second example embodiment, the example in which the corrected displacement amount is used as the value based on the displacement amount is described, but the value of the determined parameter may be used as the value based on the displacement amount. The corrected displacement information according to the present modification includes, for example, a parameter value that is a value of a parameter included in the selected displacement model determined based on the displacement amount included in the displacement information. In this case, the information processing apparatus 200 may have a function in which the corrected displacement amount in the second example embodiment is replaced with the value of the determined parameter (parameter value). The information processing apparatus 200 may execute processing in which the corrected displacement amount in the second example embodiment is replaced with the value of the determined parameter (parameter value).

According to the present example embodiment, the corrected displacement information includes a parameter value that is a value of a parameter included in the selected displacement model determined based on the displacement amount included in the displacement information.

Accordingly, the soundness of the construction can be evaluated using the parameter value that is a value in associated with the corrected displacement amount in the second example embodiment. It is possible to accurately evaluate soundness of a construction.

### Third Example Embodiment

In the evaluation of the soundness of the construction, for example, the evaluation may be performed by excluding one or a plurality of measurement points included in a region that is out of attention (non-attention region) designated by the user.

### (Functional Configuration Example of Information Processing Apparatus 300)

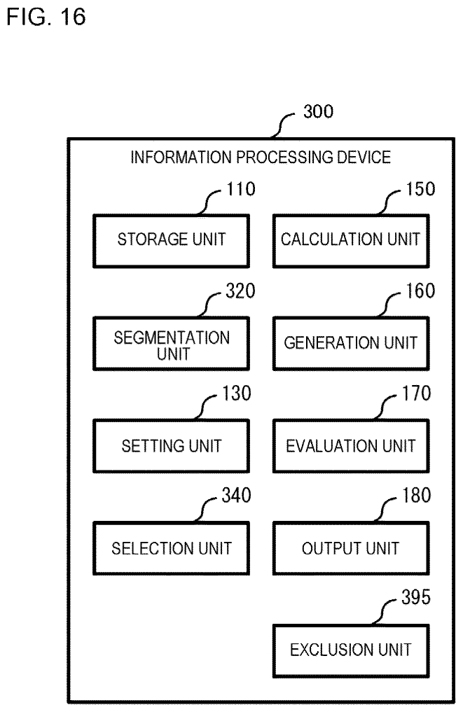

For example, as illustrated in FIG. 16, the information processing apparatus 300 includes the storage unit 110, the setting unit 130, the calculation unit 150, the generation unit 160, the evaluation unit 170, and the output unit 180. The information processing apparatus 300 includes a segmentation unit 320 and a selection unit 340 instead of the segmentation unit 120 and the selection unit 140. The information processing apparatus 300 further includes an exclusion unit 395.

For example, the exclusion unit 395 excludes a measurement point included in a non-attention region that is a region out of attention, from a plurality of measurement points included in a construction in the two-dimensional image according to an instruction of a user. For example, the exclusion unit 395 excludes a measurement point included in the non-attention region from measurement points included in the bridge BR to be evaluated. The non-attention region may be designated on a segment basis, may be designated by using a region, or may be designated for each measurement point. The method of designating the non-attention region is not limited to the method exemplified here.

For example, the segmentation unit 320 segments the plurality of measurement points for each segment of the construction, based on the three-dimensional position information of the plurality of measurement points after being excluded among the plurality of measurement points included in the construction in the two-dimensional image.

The selection unit 340 selects a plurality of pieces of displacement information including displacement amounts of the plurality of measurement points included in a preset period and a set range for the construction, among the plurality of measurement points after being excluded.

As described above, the segmentation unit 320 and the selection unit 340 may have a function of, for example, replacing “a plurality of measurement points” in the description of the first example embodiment with “a plurality of measurement points after being excluded”.

### (Processing Operation Example of Information Processing Apparatus 300)

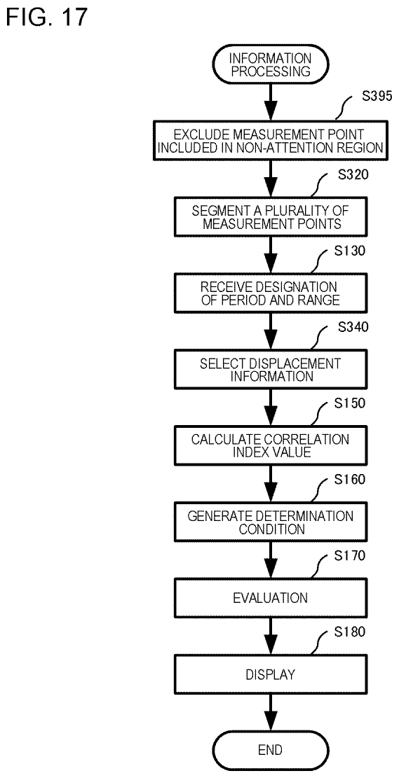

The information processing apparatus 300 may execute information processing as illustrated in FIG. 17. This information processing is started, for example, when measurement point information, construction information, and the like are stored in the storage unit 110 in advance, and a predetermined instruction is received from the user. The trigger for starting the information processing is not limited thereto.

For example, the exclusion unit 395 excludes a measurement point included in a non-attention region that is a region out of attention, from a plurality of measurement points included in a construction in the two-dimensional image according to an instruction of a user (step S395).

For example, the segmentation unit 320 segments the plurality of measurement points for each segment of the construction, based on the three-dimensional position information of the plurality of measurement points after being excluded among the plurality of measurement points included in the construction in the two-dimensional image (step S320).

Step S130 described above is executed.

The selection unit 340 selects a plurality of pieces of displacement information including displacement amounts of the plurality of measurement points included in a preset period and a set range for the construction, among the plurality of measurement points after being excluded (step S340).

Steps S150, S160, S170, and S180 described above are executed.

### (Operation and Effect)

Above, according to the present example embodiment, the information processing apparatus 300 includes the exclusion unit 395 that excludes a measurement point included in a non-attention region that is a region out of attention, from a plurality of measurement points included in a construction in the two-dimensional image according to an instruction of a user. The selection unit 340 selects a plurality of pieces of displacement information including displacement amounts of the plurality of measurement points included in a preset period and a set range for the construction, among the plurality of measurement points after being excluded.

According to this, it is possible to generate the determination condition for evaluating the soundness of the construction by excluding the measurement points included in the region not desired by the user. It is possible to generate a determination condition capable of accurately evaluating soundness of a construction.

The soundness of the construction can be evaluated using the determination condition generated by excluding the measurement points included in the region not desired by the user. It is possible to accurately evaluate soundness of a construction.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with other example embodiments.

In the plurality of flowcharts used in the above description, a plurality of steps (processes) are sequentially described, but the execution order of the steps executed in each example embodiment is not limited to the described order. In each example embodiment, the order of the illustrated steps can be changed as long as there is no problem in terms of content. Some or all of the above example embodiments may be described as the following Supplementary Notes but are not limited to the following.

Hereinafter, examples of the reference mode are added.

1.

An information processing apparatus including:
segmentation means for segmenting a plurality of measurement points for each segment of a construction in a two-dimensional image based on three-dimensional position information of the plurality of measurement points included in the construction;
selection means for selecting a plurality of pieces of displacement information including displacement amounts of the plurality of measurement points included in a preset period and a set range for the construction;
calculation means for calculating a correlation index value representing a correlation for at least one of the segments included in the set range based on the selected displacement information and environment information indicating a state of an environment around the set range; and
generation means for generating a determination condition for evaluating soundness of the construction for the at least one segment based on the correlation index value of the at least one segment.

2.

The information processing apparatus according to 1., further including:
evaluation means for evaluating soundness of the construction by using the determination condition for the at least one segment, in which
the set range includes a plurality of first ranges to be evaluated and at least one second range for generating the determination condition, and
the correlation index value includes a plurality of first index values for the at least one segment included in the first range and a second index value for the at least one segment included in the at least one second range, and
the determination condition for the at least one segment is generated based on the second index value for the at least one segment, and
the soundness of the construction is evaluated for each of the at least one segment included in the first range by using the determination condition for the associated segment.

3.

The information processing apparatus according to 2., in which the calculation means includes:
integration means for integrating, for each segment, displacement information including a displacement amount of a measurement point included in the at least one second range in the period and generating integrated displacement information including the displacement amount of the measurement point for each segment,
first index calculation means for calculating the first index value for the at least one segment based on the displacement information of the measurement point included in the first range in the period and the environment information, and
second index calculation means for calculating the second index value for the at least one segment based on the integrated displacement information for each of the segment in the period and the environment information.

4.

The information processing apparatus according to any one of 1. to 3., further including:
model selection means for selecting a displacement model representing a relationship between the displacement information and the environment information based on structure information indicating a structure of the construction, in which
the calculation means includes
correction means for generating corrected displacement information by using the selected displacement model and the displacement information of the set range in the period, and
index calculation means for calculating the correlation index value based on the corrected displacement information in the set range in the period and the environment information indicating the state of the environment around the set range.

5.

The information processing apparatus according to 4., in which
the plurality of displacement models are provided, and
the plurality of displacement models include different displacement models according to a type of the segment.

6.

The information processing apparatus according to 4, or 5., in which
the corrected displacement information includes a corrected displacement amount obtained by correcting a displacement included in the displacement information by using the selected displacement model or a parameter value that is a value of a parameter determined based on a displacement in the displacement information and included in the selected displacement model.

7.

The information processing apparatus according to any one of 1. to 6., further including:
exclusion means for excluding the measurement point included in a non-attention region that is a region out of attention, from the plurality of measurement points in the construction in the two-dimensional image in accordance with an instruction of a user, in which
the selection means selects the plurality of pieces of displacement information including displacement amounts of the plurality of measurement points included in the preset period and the set range for the construction among the plurality of measurement points after exclusion.

8.

An information processing method performed by one or more computer, the method including:
segmenting a plurality of measurement points for each segment of a construction in a two-dimensional image based on three-dimensional position information of the plurality of measurement points included in the construction;
selecting a plurality of pieces of displacement information including displacement amounts of the plurality of measurement points included in a preset period and a set range for the construction;
calculating a correlation index value representing a correlation for at least one of the segments included in the set range based on the selected displacement information and environment information indicating a state of an environment around the set range; and
generating a determination condition for evaluating soundness of the construction for the at least one segment based on the correlation index value of the at least one segment.

9.

The information processing method according to 8., further including:
evaluating soundness of the construction by using the determination condition for the at least one segment, in which
the set range includes a plurality of first ranges to be evaluated and at least one second range for generating the determination condition, and
the correlation index value includes a plurality of first index values for the at least one segment included in the first range and a second index value for the at least one segment included in the at least one second range, and
the determination condition for the at least one segment is generated based on the second index value for the at least one segment, and
the soundness of the construction is evaluated for each of the at least one segment included in the first range by using the determination condition for the associated segment.

10.

The information processing method according to 9., in which the calculating of a correlation index value includes:
integrating, for each segment, displacement information including a displacement amount of a measurement point included in the at least one second range in the period and generating integrated displacement information including the displacement amount of the measurement point for each segment,
calculating the first index value for the at least one segment based on the displacement information of the measurement point included in the first range in the period and the environment information, and
calculating the second index value for the at least one segment based on the integrated displacement information for each of the segment in the period and the environment information.

11.

The information processing method according to any one of 8. to 10., further including:
selecting a displacement model representing a relationship between the displacement information and the environment information based on structure information indicating a structure of the construction, in which
the calculating of a correlation index value includes
generating corrected displacement information by using the selected displacement model and the displacement information of the set range in the period, and
calculating the correlation index value based on the corrected displacement information in the set range in the period and the environment information indicating the state of the environment around the set range.

12.

The information processing method according to 11., in which
the plurality of displacement models are provided, and
the plurality of displacement models include different displacement models according to a type of the segment.

13.

The information processing method according to 11. or 12., in which
the corrected displacement information includes a corrected displacement amount obtained by correcting a displacement included in the displacement information by using the selected displacement model or a parameter value that is a value of a parameter determined based on a displacement in the displacement information and included in the selected displacement model.

14.

The information processing method according to any one of 8. to 13., further including:
excluding the measurement point included in a non-attention region that is a region out of attention, from the plurality of measurement points in the construction in the two-dimensional image in accordance with an instruction of a user, in which
the selecting of a plurality of pieces of displacement information includes selecting the plurality of pieces of displacement information including displacement amounts of the plurality of measurement points included in the preset period and the set range for the construction among the plurality of measurement points after exclusion.

15.

A program causing one or more computer to perform:
segmenting a plurality of measurement points for each segment of a construction in a two-dimensional image based on three-dimensional position information of the plurality of measurement points included in the construction;
selecting a plurality of pieces of displacement information including displacement amounts of the plurality of measurement points included in a preset period and a set range for the construction;
calculating a correlation index value representing a correlation for at least one of the segments included in the set range based on the selected displacement information and environment information indicating a state of an environment around the set range; and
generating a determination condition for evaluating soundness of the construction for the at least one segment based on the correlation index value of the at least one segment.

16.

The program according to 15., further including:
evaluating soundness of the construction by using the determination condition for the at least one segment, in which
the set range includes a plurality of first ranges to be evaluated and at least one second range for generating the determination condition, and
the correlation index value includes a plurality of first index values for the at least one segment included in the first range and a second index value for the at least one segment included in the at least one second range, and
the determination condition for the at least one segment is generated based on the second index value for the at least one segment, and
the soundness of the construction is evaluated for each of the at least one segment included in the first range by using the determination condition for the associated segment.

17.

The program according to 16., in which the calculating of a correlation index value includes:
integrating, for each segment, displacement information including a displacement amount of a measurement point included in the at least one second range in the period and generating integrated displacement information including the displacement amount of the measurement point for each segment,
calculating the first index value for the at least one segment based on the displacement information of the measurement point included in the first range in the period and the environment information, and
calculating the second index value for the at least one segment based on the integrated displacement information for each of the segment in the period and the environment information.

18.

The program according to any one of 15. to 17., further including:
selecting a displacement model representing a relationship between the displacement information and the environment information based on structure information indicating a structure of the construction, in which
the calculating of a correlation index value includes
generating corrected displacement information by using the selected displacement model and the displacement information of the set range in the period, and
calculating the correlation index value based on the corrected displacement information in the set range in the period and the environment information indicating the state of the environment around the set range.

19.

The program according to 18., in which
the plurality of displacement models are provided, and
the plurality of displacement models include different displacement models according to a type of the segment.

20.

The program according to 18. or 19., in which
the corrected displacement information includes a corrected displacement amount obtained by correcting a displacement included in the displacement information by using the selected displacement model or a parameter value that is a value of a parameter determined based on a displacement in the displacement information and included in the selected displacement model.

21.

The program according to any one of 15. to 20., further including:
excluding the measurement point included in a non-attention region that is a region out of attention, from the plurality of measurement points in the construction in the two-dimensional image in accordance with an instruction of a user, in which
the selecting of a plurality of pieces of displacement information includes selecting the plurality of pieces of displacement information including displacement amounts of the plurality of measurement points included in the preset period and the set range for the construction among the plurality of measurement points after exclusion.

22.

A recording medium on which a program according to any one of 15. to 21. is recorded.

1. An information processing apparatus comprising:
a memory configured to store instructions; and
a processor configured to execute the instructions to:
segment a plurality of measurement points for each segment of a construction in a two-dimensional image based on three-dimensional position information of the plurality of measurement points included in the construction;
select a plurality of pieces of displacement information including displacement amounts of the plurality of measurement points included in a preset period and a set range for the construction;
calculate a correlation index value representing a correlation for at least one of the segments included in the set range based on the selected displacement information and environment information indicating a state of an environment around the set range; and
generate a determination condition for evaluating soundness of the construction for the at least one segment based on the correlation index value of the at least one segment.

2. The information processing apparatus according to claim 1, wherein
the processor configured to further execute the instructions to:
evaluate soundness of the construction by using the determination condition for the at least one segment, and
the set range includes a plurality of first ranges to be evaluated and at least one second range for generating the determination condition, and
the correlation index value includes a plurality of first index values for the at least one segment included in the first range and a second index value for the at least one segment included in the at least one second range, and
the determination condition for the at least one segment is generated based on the second index value for the at least one segment, and
the soundness of the construction is evaluated for each of the at least one segment included in the first range by using the determination condition for the associated segment.

3. The information processing apparatus according to claim 2, wherein calculating a correlation index value includes:
integrating, for each segment, displacement information including a displacement amount of a measurement point included in the at least one second range in the period and generating integrated displacement information including the displacement amount of the measurement point for each segment,
calculating the first index value for the at least one segment based on the displacement information of the measurement point included in the first range in the period and the environment information, and
calculating the second index value for the at least one segment based on the integrated displacement information for each of the segment in the period and the environment information.

4. The information processing apparatus according to claim 1, wherein
the processor configured to further execute the instructions to:
select a displacement model representing a relationship between the displacement information and the environment information based on structure information indicating a structure of the construction, and
calculating a correlation index value includes
generating corrected displacement information by using the selected displacement model and the displacement information of the set range in the period, and
calculating the correlation index value based on the corrected displacement information in the set range in the period and the environment information indicating the state of the environment around the set range.

5. The information processing apparatus according to claim 4, wherein
the plurality of displacement models are provided, and
the plurality of displacement models include different displacement models according to a type of the segment.

6. The information processing apparatus according to claim 4, wherein
the corrected displacement information includes a corrected displacement amount obtained by correcting a displacement included in the displacement information by using the selected displacement model or a parameter value that is a value of a parameter determined based on a displacement in the displacement information and included in the selected displacement model.

7. The information processing apparatus according to claim 1, wherein
the processor configured to further execute the instructions to:
exclude the measurement point included in a non-attention region that is a region out of attention, from the plurality of measurement points in the construction in the two-dimensional image in accordance with an instruction of a user, and
selecting the plurality of pieces of displacement information includes selecting the plurality of pieces of displacement information including displacement amounts of the plurality of measurement points included in the preset period and the set range for the construction among the plurality of measurement points after exclusion.

8. An information processing method performed by one or more computer, the method comprising:
segmenting a plurality of measurement points for each segment of a construction in a two-dimensional image based on three-dimensional position information of the plurality of measurement points included in the construction;
selecting a plurality of pieces of displacement information including displacement amounts of the plurality of measurement points included in a preset period and a set range for the construction;
calculating a correlation index value representing a correlation for at least one of the segments included in the set range based on the selected displacement information and environment information indicating a state of an environment around the set range; and
generating a determination condition for evaluating soundness of the construction for the at least one segment based on the correlation index value of the at least one segment.

9. A non-transitory computer readable media storing program causing one or more computer to perform:
segmenting a plurality of measurement points for each segment of a construction in a two-dimensional image based on three-dimensional position information of the plurality of measurement points included in the construction;
selecting a plurality of pieces of displacement information including displacement amounts of the plurality of measurement points included in a preset period and a set range for the construction;
calculating a correlation index value representing a correlation for at least one of the segments included in the set range based on the selected displacement information and environment information indicating a state of an environment around the set range; and
generating a determination condition for evaluating soundness of the construction for the at least one segment based on the correlation index value of the at least one segment.
